(19) United States
(12) Patent Application Publication
(10) Pub. No.: US 2017/0126538 A1
(43) Pub. Date: May 4, 2017

(54) TESTING IN A CONTENT DELIVERY NETWORK

(71) Applicant: Fastly, Inc., San Francisco, CA (US)

(72) Inventor: Simon Wistow, San Francisco, CA (US)

(21) Appl. No.: 15/285,097

(22) Filed: Oct. 4, 2016

Related U.S. Application Data
(60) Provisional application No. 62/247,486, filed on Oct. 28, 2015.

(51) Int. Cl. H04L 12/26

(52) U.S. Cl. CPC H04L 43/50; H04L 43/06; H04L 43/045

(57) ABSTRACT

Testing in a content delivery network includes the CDN receiving test data pertaining to the testing of content-related code such as new code to be deployed in the content delivery network. During testing, performance data from the CDN can be compared to evaluation data and used to generate a report on the testing results, such as recommendations and examples of problems with tested code. The test data can include content identification data, edge cache node identification data, new code, and other content-related code. Testing at an edge cache node may determine whether problems exist with regard to caching and traffic flow and may include CDN regression testing and redirection of a portion of network traffic that is intended for old content-related code to new content-related code.

### RELATED APPLICATIONS

This application hereby claims the benefit of and priority to U.S. Provisional Patent Application 62/247,486, titled “TESTING IN A CONTENT DELIVERY NETWORK,” filed Oct. 28, 2015, and which is hereby incorporated by reference in its entirety.

### TECHNICAL FIELD

Aspects of the disclosure are related to the field of content delivery networks and the like.

### TECHNICAL BACKGROUND

Internet web pages and other network-provided content typically are served to end users via networked computer systems. End user requests for network content are processed and the content is responsively provided over various network links. These networked computer systems can include origin or hosting servers that originally host network content, such as web servers for hosting a news website. However, computer systems consisting solely of individual content origins or hosts can become overloaded and slow due to frequent requests of content by end users.

Content delivery networks (CDNs) add a layer of caching between content providers' original servers and end users. Content delivery networks typically have multiple, distributed cache nodes that provide end users with faster access to content. When an end user requests content, such as a web page, the request is handled by a cache node that is configured to respond to the end user request (e.g., instead of an origin server). Specifically, when an end user directs a content request to a given origin server, the domain name system (DNS) resolves to a cache node (frequently the node is selected as an optimized server) instead of the origin server and the cache node handles that request.

Thus a cache node acts as a proxy or cache for one or more origin servers. Various types of origin server content can be cached in the content delivery network's various cache nodes. When all or a portion of the requested content has not been cached by a cache node, that cache node typically requests the relevant content (or portion thereof) from the appropriate origin server(s) on behalf of the end user.

### Overview

Various implementations of testing in a content delivery network include selecting, identifying and/or defining test data pertaining to the testing of content-related code such as new code to be deployed in the content delivery network. All or part of such test data can be provided by an admin user in the content delivery network and can be used to set up testing of the relevant content-related code. When the testing is being performed, operational performance data can be collected from the CDN and compared to operational evaluation data, which can be provided by the CDN, an admin user, historical data relating to the CDN, or a combination of these sources. The operational performance data can be generated by running the test(s) using the CDN (e.g., actual, pseudo and/or virtual components and/or equipment in connection with a CDN). A report can then be generated to provide an admin user with feedback on the test results, for example noting recommendations and examples of problems with the content-related code being tested.

In some implementations the testing is run using the content-related code on a CDN edge cache node or other network component. The test data can include content identification data, edge cache node identification data, new code, and other content-related code. Testing at an edge cache node may determine whether problems exist with regard to caching, traffic flow and others. Visual debugging depicting traffic for identified content and/or an identified edge cache node may also be provided.

In some implementations the test data comprises content-related code to be tested using CDN regression testing, for example using CDN equipment such as a server or edge cache node. The regression tests implemented in such examples can be provided by an admin user and/or can be supplied as automated or otherwise available tests by the content delivery network, which can perform the regression testing and/or other tests on a periodic basis.

In some implementations the test data comprises content identification data comprising new content-related code to be implemented in an edge cache node, wherein a preselected portion of CDN traffic intended for old content-related code is redirected to the new content-related code. Operational data is collected from the CDN pertaining to performance of the new content-related code in connection with the preselected portion of traffic and a report regarding that performance is generated.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the views. While multiple embodiments are described in connection with these drawings, the disclosure is not limited to the embodiments disclosed herein. On the contrary, the intent is to cover all alternatives, modifications, and equivalents.

FIG. 1 illustrates a communication system.

FIG. 2 illustrates a method of operation of a content delivery system.

FIG. 3 illustrates a method of operation of a content delivery system.

FIG. 4 illustrates a communication system.

FIG. 5 illustrates a communication system.

FIG. 6 illustrates a method of operation of a content delivery system.

FIG. 7 illustrates a non-limiting example of a testing data collection and processing unit.

FIG. 8A illustrates a non-limiting example of a user interface.

FIG. 8B illustrates a non-limiting example of a user interface.

### DETAILED DESCRIPTION

Network content such as web content typically comprises text, hypertext markup language (HTML) pages, pictures, digital media content, video, audio, code, scripts, and/or other content viewable on and rendered by an end user device in a browser or other specialized application. Such network-provided content, such as Internet web pages and the like, is typically served to end users via networked computer systems that provide requested content over various network links. A content delivery network (a “CDN”) is an example of such a networked computer system.

Content delivery networks employ edge cache nodes that are configured to respond to end user requests for content (e.g., a web page) by sending the web page's “primary resource” (e.g., a hypertext mark-up language (HTML) file, such as XHTML or HTMLS files and the like) to an end user device's web browser, which “loads” (or “renders” or “parses”) the web page in accordance with an appropriate standard (e.g., the HTMLS specification) and/or model (e.g., the Document Object Model (DOM) that organizes the nodes of a document (web page) in a tree structure known as a DOM tree). Web browsers identify and organize the various elements of a web page to generate the page displayed on a user's device.

Implementations herein can be used to facilitate testing of content-related code (e.g., new content and new content-related code, collectively “new code”) in a content delivery network, especially new code developed and supplied by content providers. This testing can take place in a diagnostic tool context, a unit testing context, and/or a copying and staging context. These various implementations permit the evaluation and gradual introduction of new code into a CDN while minimizing the risk of problems with and/or major failure of the new code. The new code can be any sort of code that can be included in web-accessible content. Non-limiting examples include JavaScript, Java, HTML, CSS, embedded scripting, and broadly, any executable code, any declarative statements (i.e., scripting language or XML markup), and compliable code, etc.

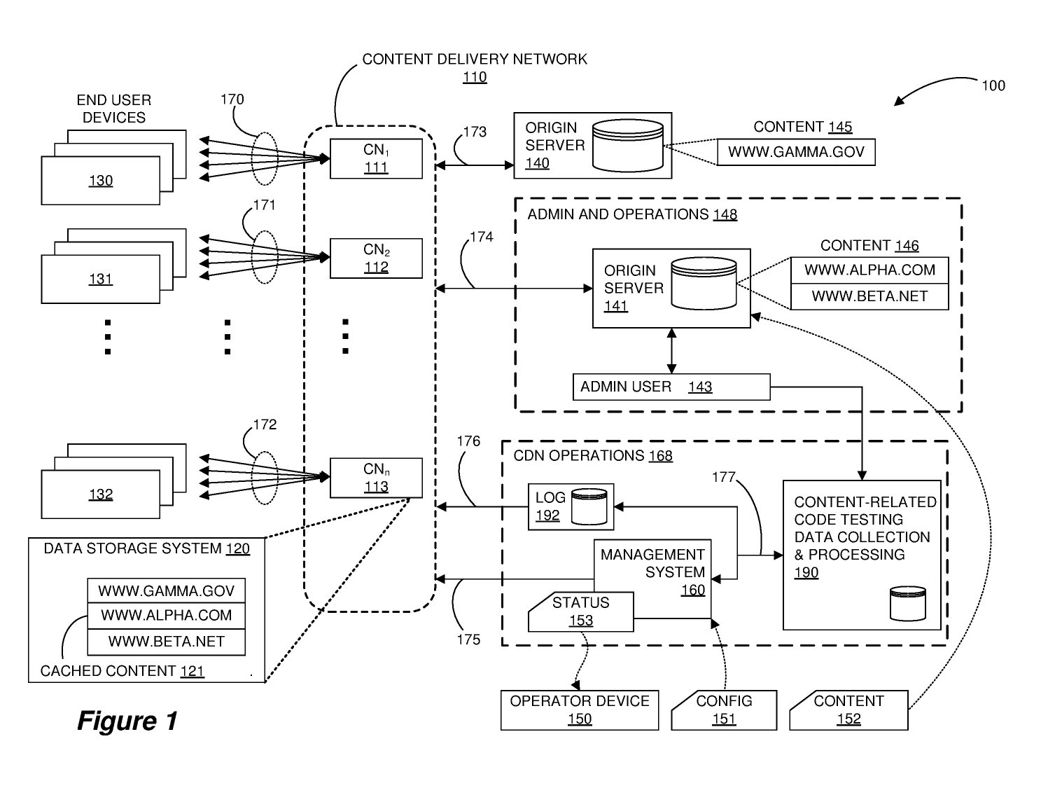

FIG. 1 illustrates an exemplary content delivery system 100 that includes content delivery network (CDN) 110, end user devices 130, 131, 132, origin servers 140-141, and a CDN operations unit 168 that includes management system 160 and a content-related code testing data collection and processing unit 190 (which may be a single unit or device, or may be made up of multiple units or devices working in concert). Content delivery network 110 includes one or more edge cache nodes (CNs) 111, 112, 113, each of which can include suitable processing resources and one or more data storage systems. Each CN 111-113 communicates with each other CN over CDN network links. Each of CN 111-113 can include one or more data storage systems, such as data storage system 120 illustrated for CN 113. End user devices 130-132 are representative of a plurality of end user communication devices that can request and receive (i.e., consume) content from network 110. The transfer of content from CDN 110 to a given end user device is initiated when a specific user device 130-132 associated with a given cache node 111-113 transmits a content request to its corresponding cache node (any number of end user devices 130-132 can be associated with a single cache node). Cache nodes 111-113 and end users 130-132 communicate over associated network links 170, 171, 172. Other network components likewise communicate over appropriate links. Content delivery network 110, management system 160 and log 192 communicate over links 175, 176.

Content cached in and/or obtained by one of the CNs 111-113 is used to respond to end user requests by transmitting requested content to the end user device. CNs 111-113 can cache content from origin servers 140-141 periodically, on demand, etc. and can also seek and obtain content that is not cached by communicating directly with origin servers 140-141 (e.g., over associated network links 173-174). FIG. 1 shows cached content 121 included in data storage system 120 of cache node 113 as comprised of content 145-146. Other configurations are possible, including subsets of content 145-146 being cached in individual ones of CN 111-113. Although FIG. 1 shows content 145-146 of origin servers 140-141 being cached by data storage system 120, other content can be handled by CN 111-113. For example, dynamic content generated by activities of end user devices 130-132 need not originally reside on origin servers 140-141, and can be generated due to scripting or code included in web page content delivered by CN 111-113.

Management system 160 and its associated components collect and deliver various administrative, operational and other data, for example network and component configuration changes and status information for various parties such as an admin user (e.g., system operators, origin server operators, managers and the like). For example, operator device 150 can transfer configuration data 151 for delivery to management system 160, where configuration data 151 can alter the handling of network content requests by CNs 111-113, among other operations. Also, management system 160 can monitor status information for the operation of CDN 110, such as operational statistics, and provide status information 153 to operator device 150. Moreover, operator device 150 can transfer content 152 for delivery to origin servers 140-141 to include in content 145-146. Although one operator device 150 is shown in FIG. 1, it should be understood that this is merely representative and communication system 100 can include multiple operator devices for receiving status information, providing configuration information, or transferring content to origin servers.

With specific regard to implementations of testing and evaluating content-related code such as new code to be implemented in connection with CDN 100, FIG. 1 illustrates one or more implementations of a new code diagnostic and testing system, where admin users can include (but are not limited to) individuals associated with various types of parties such as content providers. Content-related code testing data collection and processing unit 190 is connected to various aspects of the CDN operation (e.g., management system 160 and/or log 192 via link 177, perhaps others). Origin server 141 of FIG. 1 is part of administration and operations 148 that also include an admin user unit 143, which can be one or more specialized or specially-configured computers and associated apparatus. The admin user unit 143 is in communication with the CDN's code testing data collection and processing unit 190 through any suitable means. Implementations of admin user unit 143 can provide admin user personnel with graphical and/or other admin user means for communicating with unit 190, as noted in connection with various implementations disclosed herein. Unit 190 may also be connected to various other components of the admin user unit 143 and/or other content delivery network contact points in order to carry out actions that are initiated (e.g., invoked or otherwise called for) to test and evaluate content-related code such as new code to be implemented in CDN 110.

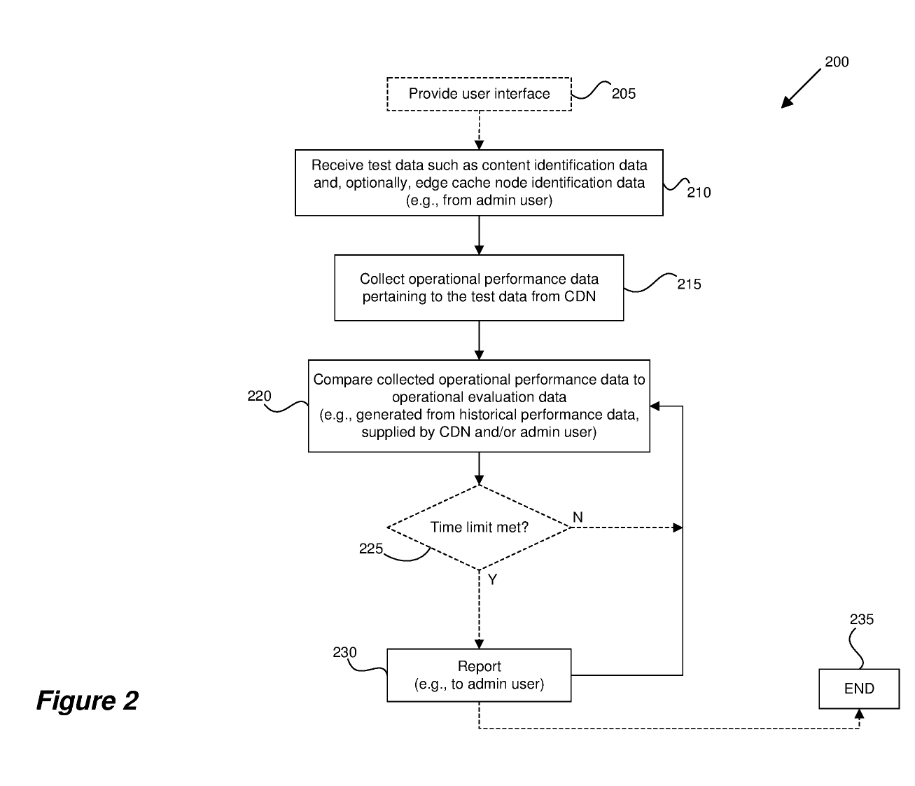

FIG. 2 illustrates one or more non-limiting examples of a method of operation 200 of a content delivery network implementing diagnostic and related testing of content-related code such as new code. Test data such as content identification and edge cache node identification data are received (210). The test data can be selected, identified and/or defined by an admin user and/or the CDN and can also be based on historical data from CDN operation, but is not limited to these sources. This identification data can come from an admin user at a content provider or the like as a way for that admin user to determine whether content is being cached and distributed optimally (or, at least, whether content caching and/or distribution can be improved). The CDN then collects operational performance data for CDN traffic pertaining to the received test data (215). This collected data is compared to appropriate operational evaluation data (220), which can be limits, ranges and/or metrics in some implementations. Such a comparison can include evaluation of causes of any sub-optimal performance relating to identified content. The operational evaluation data may include performance goals established by the CDN operator, by the admin user, and/or by distilling performance peaks and preferences based on historical performance data relating to the identified edge cache node, the CDN as a whole, and/or the admin user's own content delivery history. The comparison can then yield a performance report (230) that can contain a performance assessment, recommended content changes, and/or other feedback information to the admin user. In implementations where operational performance evaluations are standardized by the CDN operator, the admin user can optionally utilize an available user interface (205) to provide instructions (e.g., turning “on” and “off” automated tracking, evaluation and reporting, or establishing time periods (225) when such automated tracking and reporting is performed by the CDN), including a termination point (235) for discrete evaluations. Utilizing the reporting, the admin user can make changes to content and content-related new code, for example by compressing images and/or other data, optimizing certain content for mobile and/or other user classes, etc. In some implementations the comparison, evaluation and/or reporting can be provided in a stepwise diagnostic tool (e.g., based on unit tests) that allows the admin user to move graphically through the end user request, caching, delivery and other functions of the CDN with regard to the identified content (e.g., as a “visual debugging” function). In some implementations the admin user can also select between utilization of an actual operational edge cache node in the CDN or a virtual or pseudo node that replicates actual edge cache node operation in a given CDN.

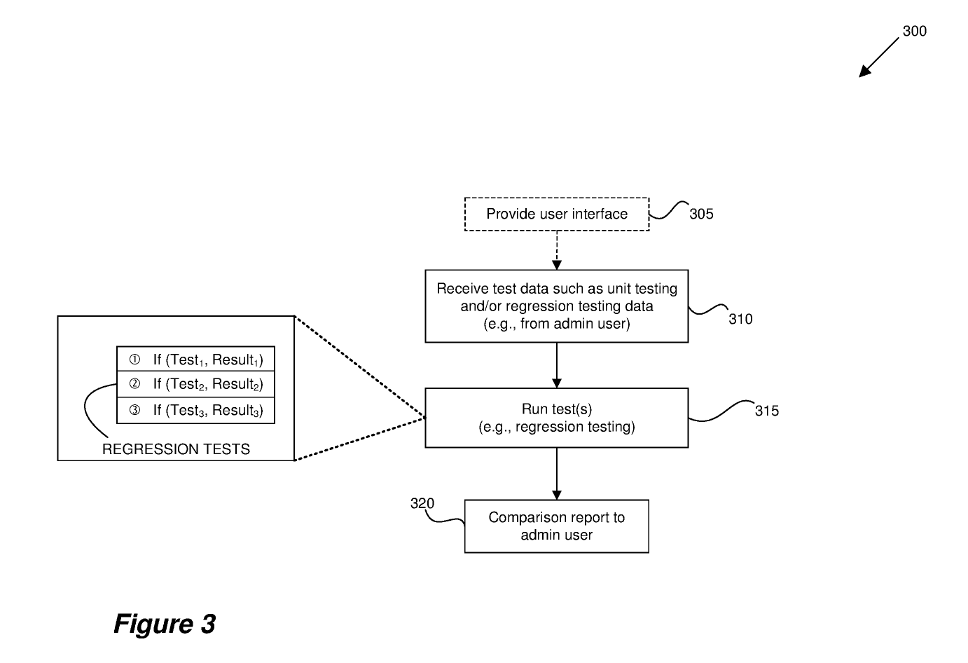

FIG. 3 illustrates one or more non-limiting examples of a method of operation 300 of a content delivery network implementing regression testing and/or unit testing evaluation of content-related code such as new sites and/or other code prior to deployment of same. The CDN receives test data (310), which can include the code for unit and/or regression tests themselves, data related to inputs and other ancillary data relating to running the tests, content and other code. Regression testing is then run using the received unit testing data (315) to detect errors and/or other problems in the content-related code (e.g., new code). A performance report is generated (320) and sent to the admin user to assist in making corrections and other changes to the tested code. In some implementations of regression testing and/or unit testing, an admin user can optionally utilize an available user interface (305) to provide instructions and unit testing data.

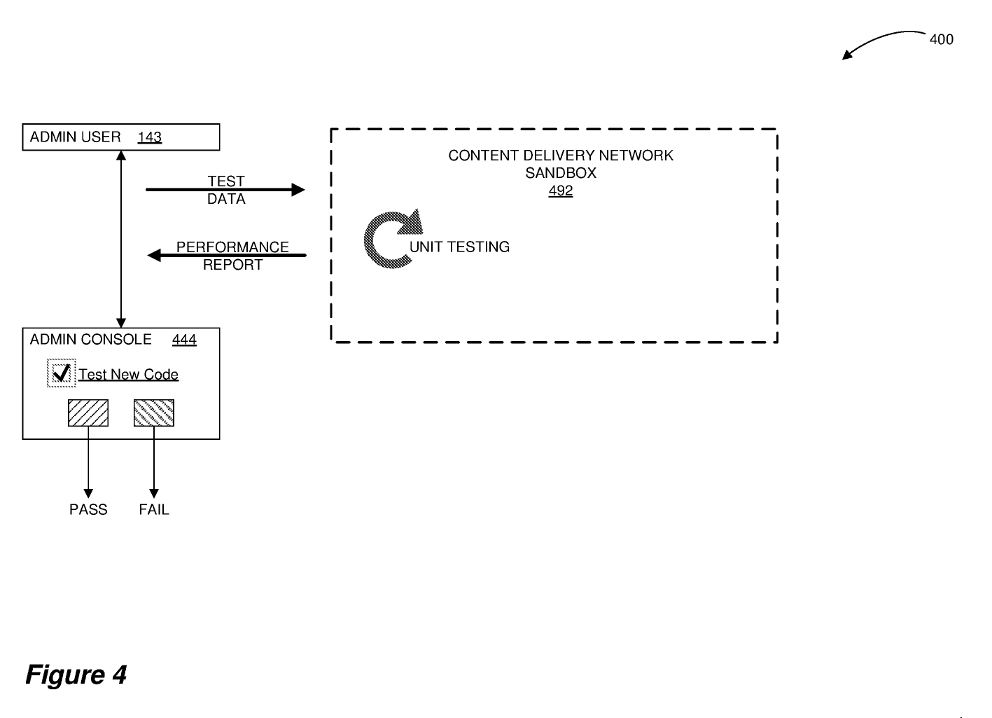

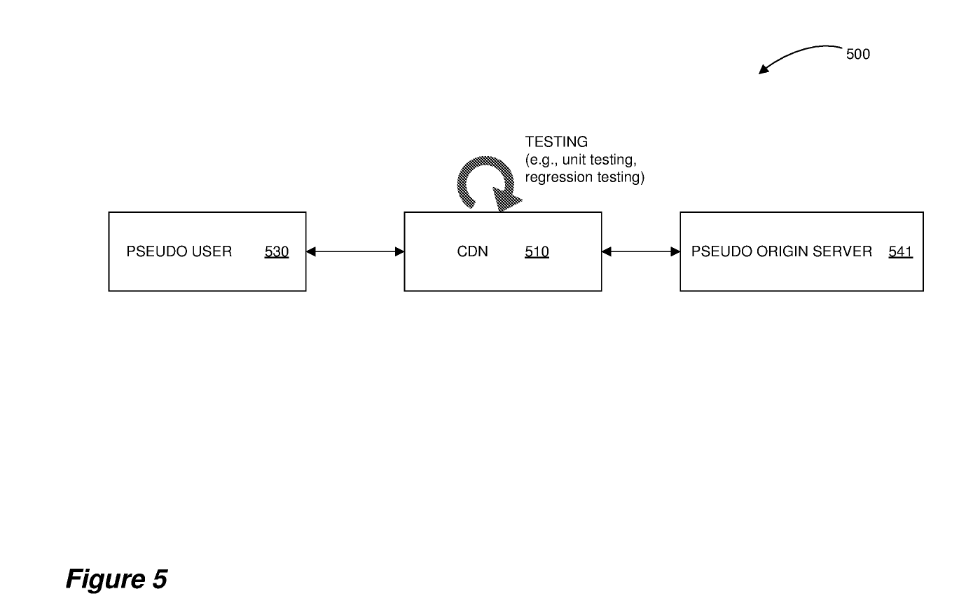

FIGS. 4 and 5 show implementations of one or more systems on which this type of testing can be run. In system 400 of FIG. 4, the admin user 143 can utilize a user interface such as admin console 444 that allows the admin user 143 to select the testing function (e.g., unit testing, regression testing). Test data is then provided to a content delivery network “sandbox” environment 492 which can be a virtual, pseudo or actual CDN. Facsimile user requests and other preselected inputs can then be used to perform the regression testing within sandbox environment 492. One or more implementations are illustrated in FIG. 5 which shows a system 500 for testing of content-related code such as new code. A pseudo user 530 interacts with a CDN environment 510, which can be a virtual, pseudo or actual CDN. Facsimile user requests and other preselected inputs can then be used in communications between the pseudo user 530 and CDN 510. A pseudo origin server 541 also can be employed and be provided with new code, old or preexisting content and other code, etc.

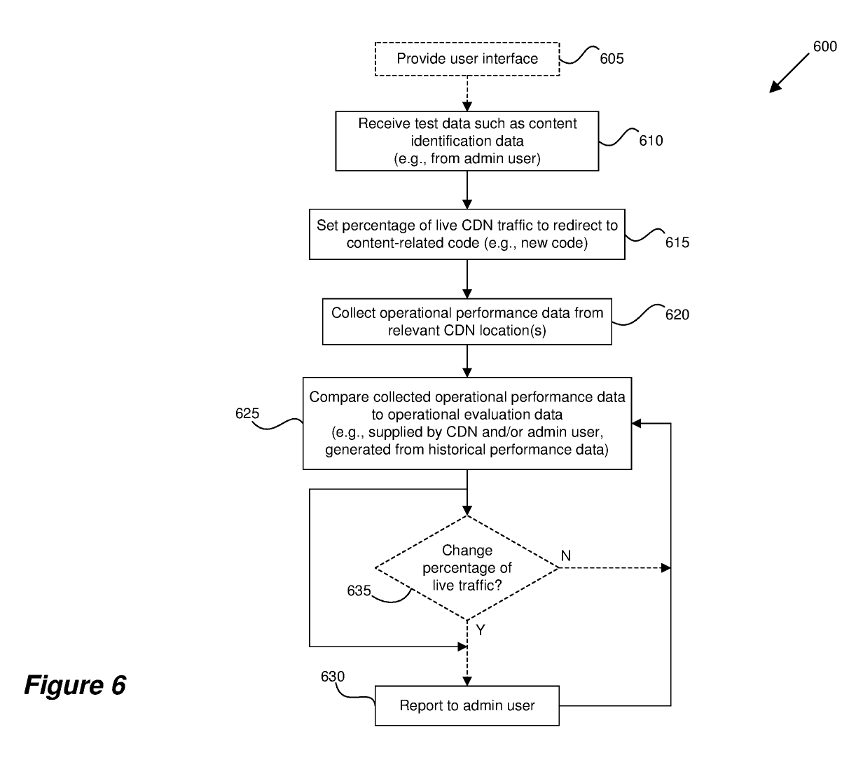

FIG. 6 illustrates one or more non-limiting examples of a method of operation 600 of a content delivery network implementing scaled staging testing of content-related code (e.g., new code) prior to full-scale deployment of same. The CDN receives test data such as content identification data (610) which can include content-related code such as new code that is intended to be deployed to edge cache nodes in the CDN. Either the CDN or the admin user can then select (615) a percentage of actual end user request traffic that will be directed to the content-related code (whether at one or more edge cache nodes of the CDN or at another location, e.g., an origin server) to test the code “live” on the CDN. Operational performance data can then be collected (620) pertaining to the performance of the content-related code in the live setting. That collected operational performance data is then evaluated (625), for example by comparing the collected operational performance data to evaluation performance data. A report can be generated (630) and sent to the admin user. Moreover, the selected percentage of live traffic directed to the content-related code can be adjusted up or down, depending on the performance. In some implementations of staging testing, an admin user can optionally utilize an available user interface (605) to provide instructions and unit testing data.

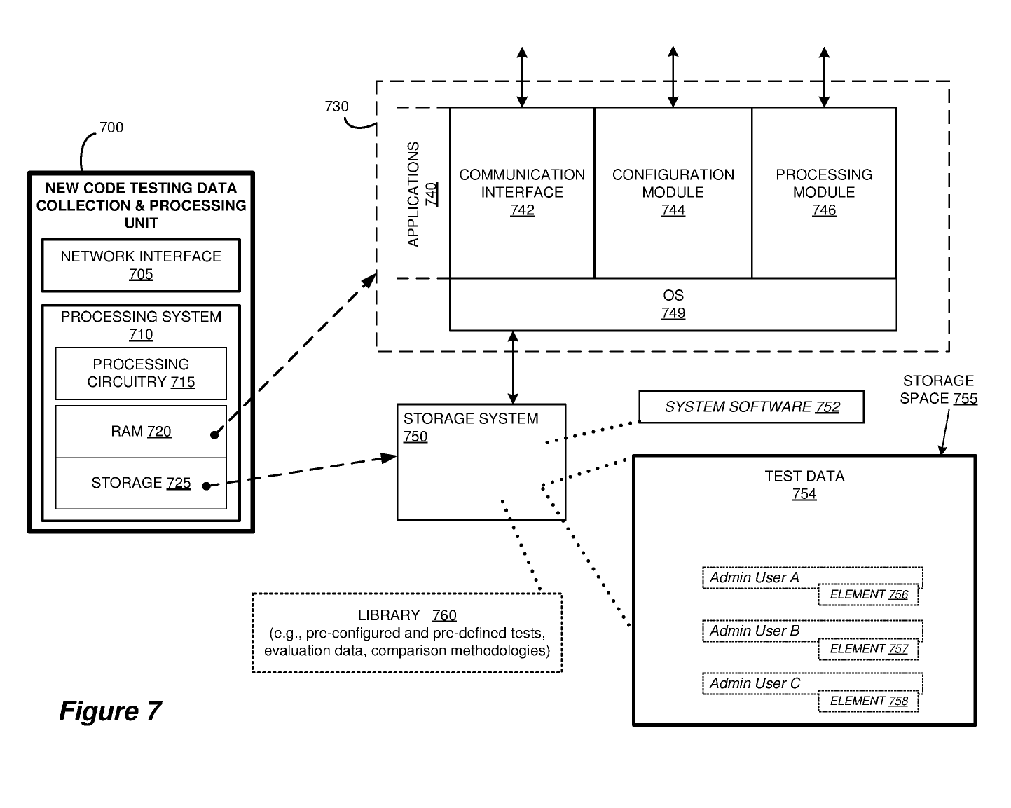

To further describe one or more implementations of the equipment and operation of testing of content-related code (e.g., new content and related new code) in a content delivery network, FIG. 7 illustrates a non-limiting example of a testing data collection and processing unit 700. Unit 700 can be an example of testing data collection and processing unit 190 of FIG. 1, although variations are possible. Unit 700 includes network interface 705 and processing system 710, although further elements can be included. Processing system 710 includes processing circuitry 715, random access memory (RAM) 720, and storage 725, although further elements can be included. Exemplary contents of RAM 720 are further detailed in RAM space 730, and exemplary contents of storage 725 are further detailed in storage system 750.

Processing circuitry 715 can be implemented within a single processing device but can also be distributed across multiple processing devices or sub-systems that cooperate in executing program instructions. Examples of processing circuitry 715 include general purpose central processing units, microprocessors, application specific processors, and logic devices, as well as any other type of processing device. In some examples, processing circuitry 715 includes physically distributed processing devices, such as cloud computing systems.

Network interface 705 includes one or more network interfaces for communicating over communication networks, such as packet networks, the Internet, and the like. The network interfaces can include one or more local or wide area network communication interfaces which can communicate over Ethernet or Internet protocol (IP) links. Network interface 705 can include network interfaces configured to communicate using one or more network addresses, which can be associated with different network links. Examples of network interface 705 include network interface card equipment, transceivers, modems, and other communication circuitry. In some implementations the network interface 705 provides the communications link with an admin user (i.e., an admin user device) configuring testing using unit 700.

RAM 720 and storage 725 together can comprise a non-transitory data storage system, although other variations are possible. RAM 720 and storage 725 can each comprise any storage media readable by processing circuitry 715 and capable of storing software. RAM 720 can include volatile and nonvolatile, removable and non-removable media implemented in any method or technology for storage of information, such as computer readable instructions, data structures, program modules, or other data. Storage 725 can include non-volatile storage media, such as solid state storage media, flash memory, phase change memory, magnetic memory, or as illustrated by storage system 750 in this example. RAM 720 and storage 725 can each be implemented as a single storage device but can also be implemented across multiple storage devices or sub-systems. RAM 720 and storage 725 can each comprise additional elements, such as controllers, capable of communicating with processing circuitry 715. In some implementations, the storage media can be a non-transitory storage media. In some implementations, at least a portion of the storage media can be transitory. It should be understood that in no case are the storage media propagated signals.

Software stored on or in RAM 720 or storage 725 can comprise computer program instructions, firmware, or some other form of machine-readable processing instructions having processes that, when executed by a processing system, direct unit 700 to operate as described herein. For example, software drives unit 700 to receive admin user selections, instructions and information concerning selections, identifications and/or definitions pertaining to testing of content-related code in a content delivery network; to collect and process operational performance and any other testing-related data and related content data; and to execute and report on comparisons of various types relating to the collected operational performance data. The software also can include user software applications. The software can be implemented as a single application or as multiple applications. In general, the software can, when loaded into a processing system and executed, transform the processing system from a general-purpose device into a special-purpose device customized as described herein.

RAM space 730 illustrates a detailed view of an non-limiting, exemplary configuration of RAM 720. It should be understood that different configurations are possible. RAM space 730 includes applications 740 and operating system (OS) 749. RAM space 730 includes RAM space for temporary storage of various types of data, such as dynamic random access memory (DRAM).

Applications 740 and OS 749 can reside in RAM space 730 during execution and operation of unit 700, and can reside in a system software storage space 752 on storage system 750 during a powered-off state, among other locations and states. Applications 740 and OS 749 can be loaded into RAM space 730 during a startup or boot procedure as described for computer operating systems and applications.

Applications 740 include communication interface 742, configuration module 744, and processing module 746. Communications interface 742 handles communications among and between one or more admin users, one or more other parties, one or more testing data collection and processing units 700 and one or more content delivery networks and their components.

Communication interface 742, configuration module 744 and processing module 746 each allow interaction between and exchange of data with components of unit 700. In some examples, each of communication interface 742, configuration module 744 and processing module 746 comprise an application programming interface (API). Communication interface 742 allows for exchanging data, messages, etc. in unit 700 by modules 744, 746, and can also receive instructions to purge or erase data from unit 700. Configuration module 744 allows for configuring of various operational features of unit 700 based on selected, identified and/or defined testing, new code, content, and other information.

Processing module 746 is configured to process data collected from the content delivery network and to do so, at least in part, in accordance with defined diagnostic testing, unit testing, regression testing, staging and other testing and diagnostic functions. Collected data can include data from sources and/or locations identified in connection with relevant diagnostic and testing parameters and functions. Processing module 746 also can perform any comparisons of collected operational performance data and evaluation data called for as part of testing content and related code in the relevant content delivery network(s). Comparisons can be performed that yield reports containing statistic, metrics, recommendations and other data or information relevant to the desired testing and/or diagnostic evaluation of new content and/or related code.

Communication interface 742, configuration module 744 and processing module 746 can each communicate with external systems via network interface 705 over any associated network links. In further examples, one or more of elements 742, 744, 746 are implemented in VCL or VCL modules.

Storage system 750 illustrates a detailed view of a non-limiting, exemplary configuration of storage 725. Storage system 750 can comprise flash memory such as NAND flash or NOR flash memory, phase change memory, magnetic memory, among other solid state storage technologies. As shown in FIG. 7, storage system 750 includes system software 752, as well as test data 754 (e.g., defined tests, comparison methodologies, content identification data, edge cache node identification data, evaluation data and information) stored in storage space 755. As described above, system software 752 can be a non-volatile storage space for applications 740 and OS 749 during a powered-down state of trigger definition unit 700, among other operating software. Test data and related information 754 include stored data such as values, parameters, names, and other information that permit various types of content-related code testing (e.g., the collection, processing and comparison of collected operational performance data and operational evaluation data; regression testing and others). In the non-limiting example of FIG. 7, data and information in storage 754 include admin user test data such as content and edge cache node selections, identifications and definitions associated with Admin User A (e.g., stored in element 756), Admin User B (e.g., stored in element 757), and Admin User C (e.g., stored in element 758).

In implementations where re-configured and/or pre-defined tests, operational evaluation data and comparison methodologies are used, a library 760 of such data and/or information can be used. Storage system 750 can therefore also include library 760, which can be updated by unit 700 and/or from other sources of information (e.g., the CDN operator, historical data) via network interface 705. Unit 700 is generally intended to represent a computing system with which at least software 730 and 749 are deployed and executed in order to render or otherwise implement the operations, methods and processes described herein. However, unit 700 can also represent any computing system on which at least software 730 and 749 can be staged and from where software 730 and 749 can be distributed, transported, downloaded, or otherwise provided to yet another computing system for deployment and execution, or yet additional distribution.

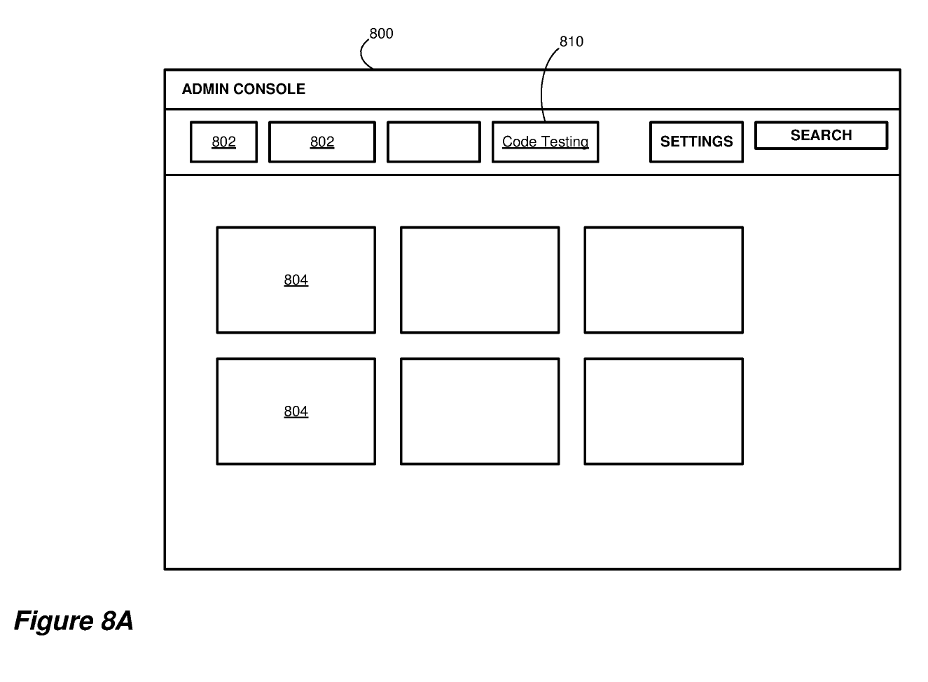

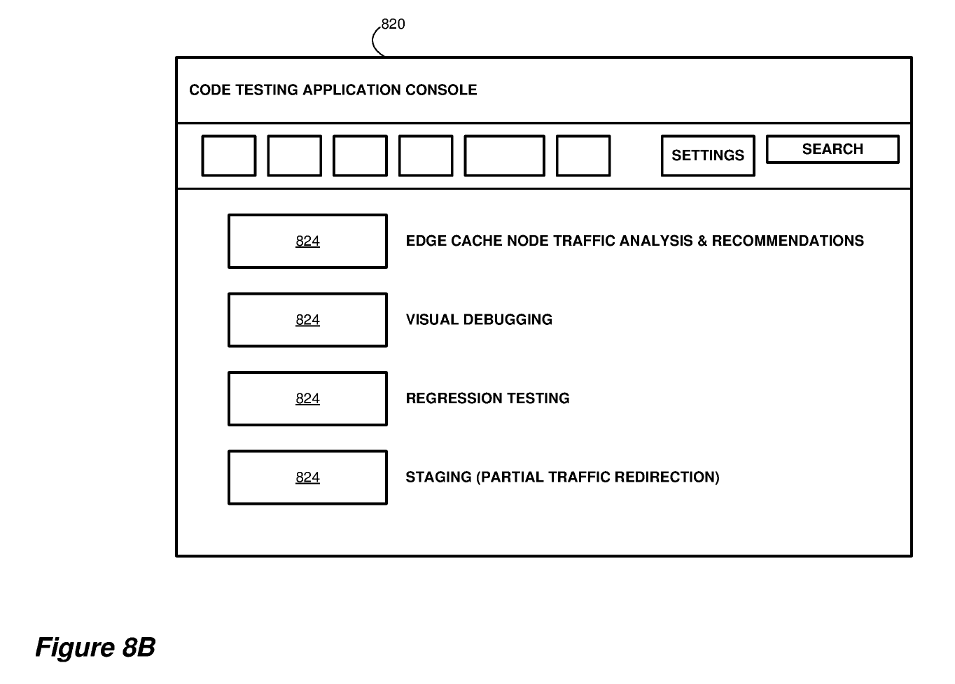

Various CDN interface modes and apparatus can be used to implement content-related code testing in a content delivery network. FIGS. 8A and 8B illustrate implementations of interfaces for electronic display that can be used to set up and execute one or more implementations of such testing by an admin user. FIG. 8A provides a non-limiting example of an admin console that can be used to provide a CDN admin user with options for reviewing account and/or other information, content updates, etc. Among the options offered to an admin user on console 800 are selection buttons 802 (e.g., applications, utilities, etc.) and other selection panels 804 (e.g., account history and/or status, billing, etc.). Such a console can be provided to an admin user unit 143 or the like via software. Included in the non-limiting example of FIG. 8A is button 810 for “Code Testing” that allows an admin user to select a content-related code testing application (or suite of applications). FIG. 8B illustrates a sample target content consumption assessment application console 820 that provides an admin user with a selection of testing methodologies that can be invoked in connection with testing content-related code by choosing from among buttons 824.

Upon selecting one of the testing modes using buttons 824, an admin user is presented with appropriate input tools for configuring the desired testing. For example, when testing optimization at an edge cache node, an input user interface would provide input tools for the admin user providing or identifying the location of content identification data, edge cache node identification data and possibly operational evaluation data that could be used by the content delivery network in evaluating throughput of the given edge cache node and/or a provider's specified content. When unit testing is being implemented, inputs presented to an admin user could include providing or identifying the location of regression tests that might be desired (one or more of the regression tests may be provided by the admin user, other regression tests might be available from a CDN library or the like), as well as code being tested. An admin user may also use an interface to select the desired results to be provided in a report being generated relative to any testing being performed.

The included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the invention. Those skilled in the art will also appreciate that the features described above can be combined in various ways to form multiple embodiments. As a result, the invention is not limited to the specific embodiments described above, but only by the claims and their equivalents.

What is claimed is:

1. A method of operating a content delivery network (CDN), the method comprising:
receiving test data pertaining to testing content-related code;
collecting operational performance data from the CDN pertaining to the test data;
comparing the collected operational performance data to operational evaluation data; and
generating a report.

2. The method of claim 1 wherein the test data comprises content identification data and edge cache node identification data.

3. The method of claim 2 wherein the content identification data comprises at least one of the following: images, mobile user content; mobile user information.

4. The method of claim 2 wherein the report comprises at least one of the following: an image compression recommendation, page optimization information regarding mobile users.

5. The method of claim 2 further comprising providing a visual debugging depiction of traffic for the identified content the identified edge cache node.

6. The method of claim 2 wherein the edge cache node identification data comprises selecting from among an actual operational edge cache node in the CDN or a virtual or pseudo node that replicates actual edge cache node operation in a given CDN.

7. The method of claim 1 wherein the test data comprises new content-related code to be tested;
further wherein collecting operational performance data from the CDN comprises performing CDN regression testing;
further wherein the report comprises CDN regression testing results.

8. The method of claim 7 wherein the test data further comprises one or more regression tests to be used in performing CDN regression testing.

9. The method of claim 7 wherein the regression testing comprises automated testing implemented by the CDN.

10. The method of claim 7 wherein the regression testing is performed periodically.

11. The method of claim 7 wherein the CDN regression testing comprises using CDN equipment comprising at least one of the following: a CDN edge cache node, a CDN server.

12. The method of claim 1 wherein the test data comprises content identification data comprising new content-related code to be implemented in an edge cache node;
the method further comprising redirecting a preselected portion of CDN traffic intended for old content-related code to the new content-related code;
wherein collecting operational data from the CDN pertaining to the test data comprises collecting data regarding performance of the new content-related code in connection with the preselected portion of traffic.

13. A method of operating a content delivery network (CDN), the method comprising:
receiving test data pertaining to testing content-related code, wherein the test data comprises new content-related code;
testing at least a portion of the new content-related code by operating the CDN using the content-related code and collecting operational performance data from the CDN pertaining to the test data;
comparing the collected operational performance data to operational evaluation data; and
generating a report pertaining to performance of the new content-related code during testing based on the comparison.

14. The method of claim 13 wherein the testing of the new content-related code is performed at an edge cache node in the content delivery network.

15. The method of claim 13 wherein the testing of the content-related code comprises redirecting a portion of CDN traffic intended for old content-related code to the new content-related code.

16. The method of claim 13 wherein the report includes at least one of the following: a recommendation regarding image compression, a recommendation regarding optimizing content for mobile users of the content delivery network.

17. The method of claim 13 wherein testing at least a portion of the new content-related code comprises performing unit testing or regression testing on the new content-related code.

18. A method of testing new content-related code in a content delivery network, the method comprising:
the content delivery network receiving test data comprising the new content-related code;
the CDN performing regression testing on the new content-related code; and
generating a report on results of the regression testing.

19. The method of claim 18 wherein performing regression testing on the new content-related code comprises running one or more regression tests received by the content delivery network as part of the received test data.

20. The method of claim 18 wherein performing regression testing on the new content-related code comprises running one or more automated regression tests.
